(19) United States
(12) Patent Application Publication
(10) Pub. No.: US 2026/0163409 A1
(43) Pub. Date: Jun. 11, 2026

(54) VEHICLE AND VEHICLE CONTROL METHOD

(71) Applicants: HYUNDAI MOTOR COMPANY, SEOUL (KR); KIA CORPORATION, SEOUL (KR)

(72) Inventor: Yi Ping Sui, Yantai (CN)

(73) Assignees: HYUNDAI MOTOR COMPANY, SEOUL (KR); KIA CORPORATION, SEOUL (KR)

(21) Appl. No.: 18/978,461

(22) Filed: Dec. 12, 2024

(30) Foreign Application Priority Data
Dec. 6, 2024 (CN) 202411793157.4

(51) Int. Cl. H02J 50/10; B60R 25/24; G07C 9/00

(52) U.S. Cl. CPC H02J 50/10; B60R 25/245; G07C 9/00309; G07C 2009/00793; G07C 2009/00984; G07C 2209/61

(57) ABSTRACT

A vehicle includes an authentication controller configured to output a fob key authentication request when a fob key approaches, and a processor configured to transmit a fob key search command to antennas in response to the fob key authentication request and output a detection signal control command to control an output of a detection signal to a wireless charging device, wherein the fob key search command includes a fob key search command for a first area in which a wireless charging pad is disposed and areas other than the first area, and an output period of the detection signal controlled according to the detection signal control command does not overlap a fob key search period for the first area.

### CROSS REFERENCE TO RELATED APPLICATIONS

This application claims the benefit of priority to Chinese Patent Application No. 202411793157.4 filed Dec. 6, 2024, the disclosure of which is herein incorporated by reference in its entirety.

### TECHNICAL FIELD

Embodiments relate to a vehicle and a vehicle control method.

### BACKGROUND

A technology of providing a wireless charging function of a user terminal in a vehicle and various functions using a fob key can improve convenience and security. The wireless charging function and the fob key can improve the user experience using wireless power transmission and wireless communication technologies, respectively.

When a driver with the fob key approaches the vehicle, a vehicle door automatically opens, and the driver's smartphone may be automatically charged by placing the smartphone on a wireless charging pad after entering the vehicle.

However, when the fob key is disposed on the wireless charging pad while the wireless charging function of the vehicle is activated, the search of the fob key often fails. This is because a low-frequency signal that searches for the fob key and a ping signal for wireless charging have the same frequency band, which causes signal interference.

The purpose of the present disclosure is to improve integrated body unit (IBU) logic of an internal low-frequency (LF) antenna that operates for searching for a fob and more accurately identify the fob by avoiding electromagnetic influence during a wireless power charging (WPC) operation.

### SUMMARY

The present disclosure is directed to providing a vehicle and a vehicle control method, which are capable of preventing signal interference between a low-frequency signal for searching for a fob key and a detection signal for wireless charging.

In addition, the present disclosure is directed to providing a vehicle and a vehicle control method, which are capable of preventing a fob key search from failing.

According to an embodiment, there is provided a vehicle including an authentication controller configured to output a fob key authentication request when a fob key approaches, and a processor configured to transmit a fob key search command to antennas in response to the fob key authentication request and output a detection signal control command to control an output of a detection signal to a wireless charging device, wherein the fob key search command includes a fob key search command for a first area in which a wireless charging pad is disposed and areas other than the first area, and an output period of the detection signal controlled according to the detection signal control command does not overlap a fob key search period for the first area.

The processor may sequentially output the fob key search commands for the first area, starting from a second area adjacent to the first area, and a third area adjacent to the second area.

The processor may control the output of the detection signal to be stopped through the detection signal control command before a period in which a fob key search operation is performed in the first area.

The processor may control the output of the detection signal to be stopped through the detection signal control command during a period in which a fob key search operation is performed in the first area.

The processor may control the detection signal to be output during a period in which the fob key search operation is performed in at least one of the second area and the third area.

A first operating frequency of the antenna for searching for the fob key may overlap a second operating frequency of the detection signal.

The wireless charging device may stop the output of the detection signal during a second period after a first period has elapsed after receiving the detection signal control command.

The search of the fob key for the first area may be performed within the second period.

The processor may receive a response signal corresponding to a fob key search signal from the fob key.

The processor may transmit a detection signal output start command or a detection signal restart command when receiving the response signal.

According to an embodiment, there is provided a vehicle control method including outputting, by an authentication controller, a fob key authentication request to a processor when a fob key approaches, transmitting, by the processor, a fob key search command to antennas in response to the fob key authentication request, and outputting, by the processor, a detection signal control command to control an output of a detection signal to a wireless charging device, wherein the fob key search command includes a fob key search command for a first area in which a wireless charging pad is disposed and areas other than the first area, and an output period of the detection signal controlled according to the detection signal control command does not overlap a fob key search period for the first area.

The transmitting of the fob key search command may include transmitting the fob key search command to a second antenna disposed in a second area adjacent to the first area, transmitting the fob key search command to a first antenna disposed in the first area, and transmitting the fob key search command to a third antenna disposed in a third area adjacent to the second area.

The outputting of the detection signal control command may include controlling the output of the detection signal to be stopped through the detection signal control command before a period in which a fob key search operation is performed in the first area.

The outputting of the detection signal control command may include controlling the output of the detection signal to be stopped through the detection signal control command during a period in which a fob key search operation is performed in the first area.

The outputting of the detection signal control command may include controlling the detection signal to be output during the period in which the fob key search operation is performed in at least one of the second area and the third area.

A first operating frequency of the antennas for searching for the fob key may overlap a second operating frequency of the detection signal.

The vehicle control method may further include stopping, by the wireless charging device receiving the detection signal control command, the output of the detection signal during a second period after a first period has elapsed.

The vehicle control method may further include performing, by the antennas, the search of the fob key for the first area within the second period.

The vehicle control method may further include transmitting, by the fob key, a response signal corresponding to a fob key search signal to the processor.

The vehicle control method may further include transmitting, by the processor receiving the response signal, a detection signal output start command or a detection signal restart command to the wireless charging device.

### BRIEF DESCRIPTION OF THE FIGURES

The above and other objects, features and advantages of the present disclosure will become more apparent to those of ordinary skill in the art by describing exemplary embodiments thereof in detail with reference to the accompanying drawings, in which:

FIG. 1 is a view for describing a vehicle according to an embodiment;

FIG. 2 is a block diagram illustrating a configuration of the vehicle according to the embodiment;

FIG. 3 is a block diagram illustrating a configuration of a user terminal according to the embodiment;

FIG. 4 is a view for describing a wireless charging device according to the embodiment;

FIG. 5 is a view for describing the arrangement of a low-frequency (LF) antenna of the vehicle according to the embodiment;

FIG. 6 is a view for describing the operation of the vehicle according to the embodiment;

FIGS. 7 and 8 are views for describing the operation of a processor according to the embodiment; and

FIGS. 9, 10, and 11 are flowcharts of vehicle control methods according to embodiments.

### DETAILED DESCRIPTION

Hereinafter, exemplary embodiments of the present disclosure will be described in detail with reference to the accompanying drawings.

However, the technical spirit of the present disclosure is not limited to some of the described embodiments, but may be implemented in various different forms, and one or more of the components among the embodiments may be used by being selectively coupled or substituted without departing from the scope of the technical spirit of the present disclosure.

In addition, terms (including technical and scientific terms) used in embodiments of the present disclosure may be construed as meaning that may be generally understood by those skilled in the art to which the present disclosure pertains unless explicitly specifically defined and described, and the meanings of the commonly used terms, such as terms defined in a dictionary, may be construed in consideration of contextual meanings of related technologies.

In addition, the terms used in the embodiments of the present disclosure are for describing the embodiments and are not intended to limit the present disclosure.

In the specification, a singular form may include a plural form unless otherwise specified in the phrase, and when described as “at least one (or one or more) of A, B, and C,” one or more among all possible combinations of A, B, and C may be included.

In addition, terms such as first, second, A, B, (a), and (b) may be used to describe components of the embodiments of the present disclosure.

These terms are only for the purpose of distinguishing one component from another component, and the nature, sequence, order, or the like of the corresponding components is not limited by these terms.

In addition, when a first component is described as being “connected,” “coupled,” or “joined” to a second component, it may include a case in which the first component is directly connected, coupled, or joined to the second component, but also a case in which the first component is “connected,” “coupled,” or “joined” to the second component by other components present between the first component and the second component.

In addition, when the first component is described as being formed or disposed on “on (above) or below (under)” the second component, “on (above)” or “below (under)” may include not only a case in which two components are in direct contact with each other, but also a case in which one or more third components are formed or disposed between the two components. In addition, when described as “on (above) or below (under),” it may include the meaning of not only an upward direction but also a downward direction based on one component.

Hereinafter, embodiments will be described in detail with reference to the accompanying drawings, and the same or corresponding components are denoted by the same reference numeral regardless of the reference numerals, and overlapping descriptions thereof will be omitted. For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

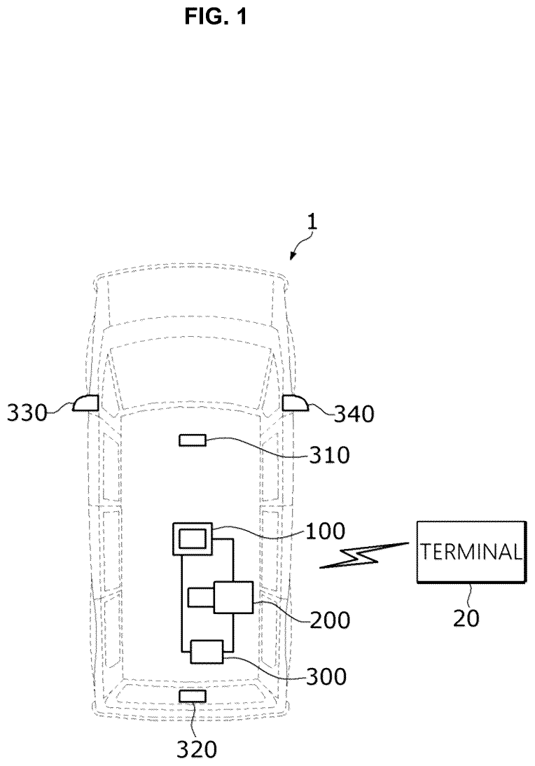

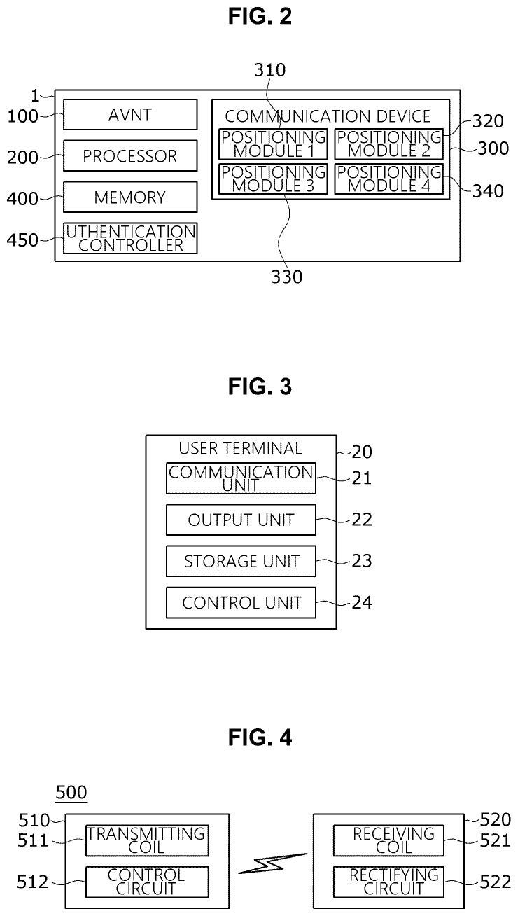

FIG. 1 is a view for describing a vehicle according to an embodiment, and FIG. 2 is a block diagram illustrating a configuration of the vehicle according to the embodiment. Referring to FIGS. 1 and 2, a vehicle 1 according to the embodiment may include an audio video navigation and telematics (AVNT) 100, a processor 200, a communication device 300, a memory 400, and a wireless charging device 500.

The vehicle 1 may include the AVNT 100 provided in a center fascia and controlling an audio device, an air conditioner, a Bluetooth® device, a seat heater, and the like.

An input device for receiving a user input may be disposed in the center fascia or the AVNT 100, and a display device for displaying operation information for at least one of functions performed in the vehicle 1 may also be disposed.

The input device may include hardware devices such as various buttons or switches, pedals, a keyboard, a mouse, a track-ball, various levers, a handle, or a stick.

In addition, the input device may include a graphical user interface (GUI), that is, a software device, such as a touch pad. The touch pad may be implemented as a touch screen panel (TSP) to form a mutual layer structure with a display panel of the display device.

The display device may function as a user interface. The display device may display the vehicle's operating state, control state, route/traffic information, energy remaining information, content requested by a driver, and the like by a processor. In addition, the display device may be configured as a touch screen capable of detecting a driver input to receive the driver's request that instructs the processor.

The interior of a vehicle body may include a keyway into which a fob type or card type remote controller may be inserted. Here, the keyway may be provided on a dashboard or center fascia and provided at a position adjacent to a driver's seat.

The vehicle 1 may transmit and receive information with a remote controller or a terminal when the remote controller is inserted into the keyway or when authentication with the remote controller or terminal is completed via a wireless communication network.

The interior of the vehicle body may further include a start button that receives on/off commands. Therefore, the vehicle starts when the start button is pressed by the user after the authentication with the remote controller or terminal is completed.

The vehicle 1 may further include a communication device for transmitting and receiving information with at least one of electronic devices and a terminal 20 that are provided in the vehicle.

The communication device 300 may include one or more components that enable communication between in-vehicle components and for example, may include at least one of a short-range communication module, a wired communication module, and a wireless communication module.

In addition, the communication device 300 may include at least one of a wired communication module and a wireless communication module for communicating with a user terminal 20 and a server 30.

For example, the short-range communication module may include various short-range communication modules for transmitting and receiving signals using a wireless communication network at a short distance, such as a Bluetooth® module, an infrared communication module, a radio frequency (RF) identification communication module, a wireless local access network (WLAN) communication module, a near-field communication (NFC) communication module, or a ZigBee communication module.

For example, the wired communication module may include not only various wired communication modules such as a controller area network (CAN) communication module, a local area network (LAN) module, a wide area network (WAN) module, and a value added network (VAN) module, but also various cable communication modules such as a universal serial bus (USB), a high definition multimedia interface (HDMI), a digital visual interface (DVI), a recommended standard 232 (RS-232), power line communication, and a plain old telephone service (POTS).

For example, a controller area network (CAN) may comprise a communication protocol designed for real-time data exchange between microcontrollers and devices within vehicles and industrial systems. CAN may allow multiple electronic control units to communicate with each other without the need for a host computer, making it useful for applications where reliable, high-speed communication is critical.

For example, a value added network (VAN) may comprise a private network that may provide businesses with secure, reliable communication channels for exchanging data and documents. VANs may offer services (e.g., data encryption, format translation, message routing, or tracking, etc.) to ensure that business documents (e.g., invoices, purchase orders, or shipping notices, etc.) may be transmitted efficiently and/or securely between trading partners. The wired communication module may further include a local interconnect network (LIN). For example, a local interconnect network (LIN) may comprise a low-cost serial communication protocol that may be used in automotive systems to connect electronic components (e.g., sensors, actuators, or control units, etc.). For example, for simplicity and/or cost-efficiency, LIN may manage functions that do not require high-speed data transfer (e.g., window controls, seat adjustments, lighting, or climate control, etc.). LIN may function on a single-master, multiple-slave architecture, where one master node may coordinate communication with multiple slave nodes.

In addition, in addition to the Wi-Fi module and the wireless broadband (WiBro) module, the wireless communication module may include a wireless communication module for supporting various wireless communication methods, such as global system for mobile communication (GSM), code division multiple access (CDMA), wideband code division multiple access (WCDMA), universal mobile telecommunications system (UMTS), time division multiple access (TDMA), and long term evolution (LTE).

The user terminal 20 communicates with the vehicle 1, receives at least one of a vehicle door lock and unlock command, a tailgate lock and unlock command, a start command, a lamp lighting command, and a start command as a user input, and transmits information corresponding to the received command to the vehicle. The user terminal 20 may transmit the information corresponding to the received command to the vehicle as a communication signal.

The user terminal 20 may be implemented as a computer or portable terminal that can be communicatively connected to the vehicle via a network.

Here, the computer may include, for example, a notebook, desktop, laptop, tablet PC, slate PC, or the like that is provided with a WEB browser, and the portable terminal is a wireless communication device that ensures portability and mobility and may include, for example, any kind of handheld-based wireless communication device such as a personal communication system (PCS), a GSM, a personal digital cellular (PDC), a personal handyphone system (PHS), a personal digital assistant (PDA), an international mobile telecommunication (IMT)-2000, CDMA-2000, WCDMA, and wireless broadband Internet (WiBro) terminals, and a smartphone, and wearable devices such as a watch, a ring, a bracelet, an anklet, a necklace, glasses, contact lenses, or a head-mounted-device (HMD).

In an embodiment, the user terminal 20 may communicate with the vehicle through a Bluetooth® low energy (BLE) communication method. The user terminal 20 may perform communication based on the Bluetooth® beacon standard (iBeacon).

The AVNT 100 is the term referring to an in-vehicle information and entertainment system and may be a system that integrates navigation, audio, video, and communication functions. The AVNT 100 may output a message generated by the processor 200 in at least one of a visual manner, an audible manner, or a combination thereof.

The AVNT 100, the processor 200, and the communication device 300 may be implemented as one module, but in the embodiment, will be described separately for convenience of description.

The AVNT 100 may be a component for providing a hardware interface integrated into the system in the vehicle. The AVNT 100 may perform system control for a screen, buttons, and various integrated information and entertainment functions.

The AVNT 100 may be installed at the center or console of the vehicle dashboard to provide vehicle information and an entertainment interface. The information and entertainment system may include AM/FM radio, satellite radio, DVDs/CDs, cassette tapes, USB MP3, dashcams, GPS navigation devices, Bluetooth®, Wi-Fi, and the like and also provide the state information of the vehicle system. In addition, the AVNT 100 may perform functions such as voice control and motion recognition.

The processor 200 may control the vehicle body such as a vehicle, doors, windows, or keys (a digital key, a smartphone key, and a fob). The processor may perform a body control function (BCM), a smart key entry/start function (SMK), a tire air pressure monitoring function (TPMS), an immobilizer function (IMMO), digital key authentication (IAU), an autonomous parking related control function (PDW), and the like. For example, the processor 200 may be a body domain controller (BDC), but is not limited thereto, and may be used to encompass a platform controller for providing electronic convenience functions to a body domain area.

The communication device 300 may perform pairing between the user terminal 20 and the vehicle 1 using a Bluetooth® signal.

The communication device 300 may include a transceiver for transmitting and receiving information using an antenna, a communication circuit, a communication processor, and the like and perform short-range communication with the user terminal 20. According to an embodiment, the communication device 300 may perform Bluetooth® communication, NFC communication, or UWB communication. The communication device 300 may be provided near a door handle of the vehicle 1 to request authentication information when it is determined that the user terminal approaches within a predetermined distance.

In the Bluetooth® standard, Bluetooth® 1.0 stipulates that a data transmission rate is 1 Mbps and a transmission distance ranges from 10 to 100 m, and communication is possible even in the presence of obstacles because Bluetooth®1.0 uses a high radio frequency of 2.4 GHz.

The communication device 300 according to the embodiment may measure the position of the user terminal under the control of the processor 200 when the user terminal including a digital key approaches the outside of the vehicle 1, unlock the vehicle door according to the result of positioning, and control the remote start of the vehicle 1 to be performed.

The communication device 300 may include a plurality of positioning modules 310 to 340. The positioning modules 310, 320, 330, and 340 may be short-range wireless communication modules, for example, low-power Bluetooth® communication (BLE) modules. Each wireless communication module may measure the strength of a wireless signal received from the user terminal. One of the plurality of wireless communication modules mounted on the vehicle 1 may be set as a master module. The master module may collect the strength of a wireless signal measured by another wireless communication module and transmit the strength to the processor.

For example, the positioning modules 310 to 340 may be composed of a Bluetooth® module, a low-power Bluetooth® module, a Wi-Fi module, and the like. The positioning modules 310 to 340 may be provided at the front, rear, left, and right sides of the vehicle 1, respectively, and may independently measure and transmit the strength of the wireless signal of the user terminal 20 to the master module.

In addition, the communication device may include a plurality of low-frequency (LF) antennas 350, 360, and 370. The LF antennas 350 to 370 are each disposed inside in-vehicle areas frequently accessed by a user, such as a driver's seat, a passenger door, and a trunk, and emit low-frequency signals to detect the fob key. LF signals may communicate with the fob key in the range of about 1 to 2 meters to detect the fob key positioned within the above range. The LF antenna may detect the fob key using a low frequency band of 125 kHz or 134.2 kHz.

The fob key receiving the low frequency signals of the LF antennas 350 to 370 may transmit RF signals to the processor in response to the low frequency signals.

The processor 200 may perform the overall control of the vehicle 1. The processor 200 may be configured to execute applications and instructions that are stored in the memory 400.

The processor 200 may be a main CPU for overall control of the vehicle 1. In an embodiment, the processor 200 may perform a pairing operation by executing a Bluetooth® application to perform communication between the Bluetooth® application and the communication device.

The processor 200 may determine a relative position of the user terminal 20 with respect to the vehicle 1. In an embodiment, the relative position may include a distance between the vehicle 1 and the user terminal 20 and a direction in which the user terminal 20 is positioned with respect to the vehicle 1.

For example, the processor 200 may determine the relative position using at least one of the Wi-Fi, Bluetooth®, and low-power Bluetooth® methods.

The processor 200 may compare the positioning result and the positioning pattern and determine the relative position of the user terminal 20.

For example, the processor 200 may determine the relative position between the vehicle and the user terminal using a received signal strength indicator (RSSI) method that measures the strength of a Wi-Fi signal to estimate a distance.

Alternatively, the processor 200 may determine the relative position between the vehicle and the user terminal using the RSSI method that measures the strength of a Bluetooth® signal to estimates a distance.

The memory 400 may store an application and various pieces of data for controlling the vehicle 1 and load the application or read or write the data at the request of the processor 200.

The memory 400 may store at least one algorithm that performs calculation or execution of various commands for operating the vehicle control system 10 according to the embodiment. The memory 400 may include at least one storage medium of a flash memory, a hard disc, a memory card, a read-only memory (ROM), a random access memory (RAM), an electrically erasable programmable ROM (EEPROM), a PROM, a magnetic memory, a magnetic disc, and an optical disc.

In the following embodiments, an example in which positioning is performed using a Bluetooth® signal, and a passive-entry-passive-start (PEPS) operation is controlled will be described.

The PEPS function may be a function that automatically performs operations such as door lock/unlock and vehicle starting after estimating the position of a smartphone through a communication module mounted on a vehicle. For example, the processor 200 may estimate the relative position of the user terminal 20 with respect to the vehicle using the signal strength of the Bluetooth® signal received from the user terminal 20 connected to the Bluetooth® module. The processor 200 may provide a passive entry function when the estimated position of the user terminal 20 approaches the vehicle and provide a passive start function when the estimated position of the user terminal 20 is inside the vehicle.

FIG. 3 is a block diagram illustrating a configuration of the user terminal according to the embodiment.

Referring to FIG. 3, the user terminal 20 may include a communication unit 21, an output unit 22, a storage unit 23, and a control unit 24.

The user terminal 20 may include a smartphone, a smart pad, a notebook computer, and the like that the user can carry. The user terminal 20 may store a digital key that generates authentication information for controlling functions such as locking and unlocking of the vehicle door, remote starting, emergency alarm, and trunk opening.

The communication unit 21 may include a transceiver for transmitting and receiving information using an antenna, a communication circuit, a communication processor, and the like and perform short-range communication with the vehicle. According to an embodiment, the communication unit 21 may perform NFC communication or UWB communication.

The output unit 22 may output information stored in the user terminal 20 in at least one of a visual manner, an audible manner, or a combination thereof. According to an embodiment, the output unit 22 may be implemented as a display device that adopts a liquid crystal display (LCD) panel, a light emitting diode (LED) panel, an organic light emitting diode (OLED) panel, a plasma display panel (PDP), or the like. The LCD may include a thin film transistor LCD (TFT-LCD). The output unit 22 may be implemented by being formed integrally with the input unit (not shown) by a touch screen panel (TSP).

The storage unit 23 may store at least one algorithm that performs calculation or execution of various commands for operating the user terminal 20 according to one embodiment of the present disclosure. The storage unit 23 may include at least one storage medium of a flash memory, a hard disc, a memory card, a ROM, a RAM, an EEPROM, a PROM, a magnetic memory, a magnetic disc, and an optical disc. The storage unit 23 may store driver information for a plurality of vehicles.

The control unit 24 may be implemented by various processing devices such as a microprocessor having a semiconductor chip capable of performing calculations or executions of various commands embedded therein and may control the operation of the user terminal 20 according to the embodiment. The control unit 24 may be electrically connected to the communication unit 21, the output unit 22, and the storage unit 23 through a wired cable or various circuits to transmit electrical signals including control commands and the like and may transmit and receive electrical signals including control commands and the like by various wireless communication networks such as a CAN.

In an embodiment, the user terminal 20 may operate as a digital key. Hereinafter, the digital key and the user terminal may be used as terms referring to the same component.

The digital key may open and close a door provided in the vehicle 1, start or stop the vehicle 1, and execute various functions included in the vehicle 1 as needed. The digital key may be a device that may use one or more of low-power Bluetooth® (BLE) communication and NFC communication.

One digital key may be operated in conjunction with a specific one vehicle 1, and a plurality of digital keys may be linked to one vehicle 1 or one digital key may be linked to a plurality of vehicles 1 as needed. In addition, there may also be a case in which a plurality of digital keys may be linked to a plurality of vehicles 1.

In addition, the digital key may be operated by being installed in a device such as a smartphone, and there may be a case in which a plurality of digital keys are installed in one smartphone. In the embodiment, the digital key is described as being operated while installed in the smartphone, but is not limited thereto, and may be installed in a device other than the smartphone as needed.

The digital key may control the vehicle 1 and to this end, may communicate with the vehicle 1 through BLE communication, UWB communication, wireless Internet network communication, or mobile communication network communication.

The digital key may be manipulated so that a user may perform various functions for controlling the vehicle 1 and may be manipulated to set one or more wireless anchors.

The digital key may search for nearby wireless anchors and register the searched wireless anchors. That is, the digital key may use various communication methods to search for wireless anchors that may be communicatively connected in a wireless communication manner. For example, when two wireless anchors are positioned near the digital key, one wireless anchor may communicate with the digital key via BLE communication, and the other may communicate with the digital key via wireless Internet communication network communication, the digital key may be communicatively connected to one of the two wireless anchors or communicatively connected to both wireless anchors.

In an embodiment, the wireless anchor may be the same component as the positioning module.

FIG. 4 is a view for describing a wireless charging device according to the embodiment. Referring to FIG. 4 together, the wireless charging device 500 may include a power transmitting device 510 including a transmitting coil 511 and a control circuit 512 and a power receiving device 520 including a receiving coil 521 and a rectifying circuit 522.

The transmitting coil 511 may be a coil built into the wireless charging device 500 of the vehicle 1 and may function to transmit power in a wireless manner, and the control circuit 512 may be an electronic circuit for controlling a charging process and managing power transmission. The power transmitting device 510 may be implemented in a wireless charging pad provided in the vehicle.

The receiving coil 521 may be a coil positioned inside the user terminal 20 and may function to receive power from the transmitting coil 511 to charge a battery, and the rectifying circuit 522 may function to convert the received AC power into DC power to charge the battery. The power receiving device 520 may be implemented in the user terminal 20.

The wireless charging device 500 may perform wireless charging through processes of transmitting a ping signal, starting charging, performing charging, and completing charging. In the following embodiments, a ping signal may be used with the same meaning as a detection signal.

When the power transmitting device 510 of the vehicle 1 is activated, the transmitting coil 511 periodically transmits a low-power ping signal to detect whether there is a nearby device capable of wireless charging and the power receiving device 520 transmits a response signal when the power receiving device 520 with the wireless charging function activated receives the ping signal of the vehicle.

The power transmitting device 510 communicates with the power receiving device 520 to find optimal charging conditions (a voltage, a current, and the like).

When the finding is completed, the transmitting coil 511 of the vehicle 1 transmits high-frequency power, and the transmitted power is transmitted to the receiving coil 521 according to the principle of electromagnetic induction.

The receiving coil 521 converts the received AC power into DC power to charge the battery of the user terminal 20.

During the charging process, the power transmitting device 510 of the vehicle 1 continuously communicates with the power receiving device 520 of the user terminal 20 to monitor a charging state, and in this process, the amount of transmitted power is adjusted to maintain optimal charging efficiency.

In addition, to manage heat generated during charging, the user terminal 20 and the wireless charging pad and device monitor a temperature and adjust a power output as needed.

When the battery of the user terminal 20 is fully charged, the power receiving device 520 transmits a charging completion signal to the power transmitting device 510.

When receiving the charging completion signal, the power transmitting device 510 stops transmitting power, thereby preventing unnecessary additional power consumption and overcharging of the battery.

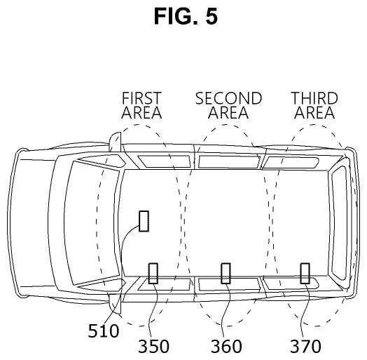

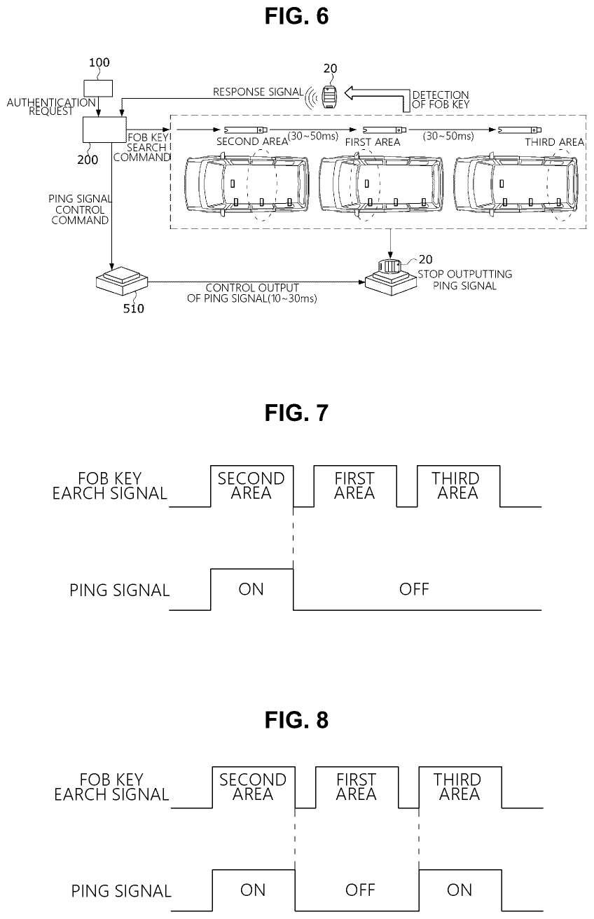

FIG. 5 is a view for describing the arrangement of a low-frequency (LF) antenna of the vehicle according to the embodiment, and FIG. 6 is a view for describing the operation of the vehicle according to the embodiment.

Referring to FIGS. 5 and 6 together, an authentication controller 450 may output a fob key authentication request when a fob key approaches. The fob key authentication process may be a process of authenticating a user through a registered fob key when a fob key user approaches a vehicle. In an embodiment, the fob key may be a digital key or a smart key. When the fob key is a digital key, the fob key may be stored in the user terminal 20.

In an embodiment, the authentication controller 450 may include a smart key unit or an identity authentication unit (IAU) that operates under the control of the AVNT 100. The fob key and the positioning module of the vehicle may be subjected to a pairing process through the exchange of an encryption key, and the paired fob key may be stored in the authentication system of the vehicle and the user terminal 20.

Hereinafter, for convenience of description, an example in which the fob key is a digital key stored in the user terminal will be described.

When the user terminal 20 in which the digital key is stored approaches the vehicle, the positioning module of the user terminal 20 is activated to attempt connection with the vehicle 1. The user terminal transmits the digital key registered in the vehicle 1, and the authentication controller 450 requests authentication of the digital key from the processor 200.

The processor 200 checks the digital key transmitted from the user terminal and verifies whether the digital key matches the registered key. When the digital key matches the registered key, the processor 200 provides the PEPS function.

The processor 200 may transmit a fob key search command to the LF antenna in response to the fob key authentication request and output a ping signal control command for controlling the output of the ping signal to the wireless charging device.

In an embodiment, the LF antenna may include a first antenna 350 disposed in a first area including a driver seat and a passenger seat, a third antenna 370 disposed in a third area including a rear seat, and a second antenna 360 disposed in a second area between the first area and the third area. Each LF antenna may individually output an LF signal for searching for the fob key under the control of the processor 200.

In an embodiment, the wireless charging pad including the power transmitting device 510 may be disposed in the first area.

The fob key search command of the processor 200 may include a fob key search command for the first area in which the wireless charging pad is disposed and areas other than the first area. That is, the fob key search command may include a fob key search command for the first antenna 350, a fob key search command for the second antenna 360, and a fob key search command for the third antenna 370.

In addition, an output period of the ping signal controlled according to the ping signal control command of the processor 200 may not overlap a fob key search period for the first area. The wireless charging device may not output the ping signal according to the ping signal control command of the processor 200 while the search of the fob key of the first antenna 350 is performed.

The processor 200 may sequentially output the fob key search commands for the first area, starting from the second area adjacent to the first area, and the third area adjacent to the second area. When receiving an authentication request from the authentication controller 450, the processor 200 may output the fob key search commands so that the second antenna 360, the first antenna 350, and the third antenna 370 sequentially perform the search of the fob key without overlapping each other. The search of the fob key of each of the antennas 350 to 370 may be performed for about 30 to 50 ms.

FIGS. 7 and 8 are views for describing the operation of a processor according to the embodiment. Referring to FIG. 7 together, the processor 200 may control the output of the ping signal to be stopped through the ping signal control command before the period in which the fob key search operation is performed in the first area. The processor 200 may output the ping signal control command so that the output of the ping signal is stopped before the fob key search operation of the first antenna 350 is performed. That is, the power transmitting device 510 may output a ping signal during the fob key search operation of the second antenna 360, but may not output the ping signal during the fob key search operation of the first antenna 350 and the fob key search operation of the third antenna 370. In this case, the ping signal control command may be a command to stop outputting the ping signal. The power transmitting device 510 may restart outputting the ping signal under the control of the processor 200 after the search of the fob key is completed.

Referring to FIG. 8 together, the processor 200 may control the output of the ping signal to be stopped through the ping signal control command during the period in which the fob key search operation is performed in the first area. The processor 200 may output the ping signal control command so that the output of the ping signal is stopped during only the period in which the fob key search operation of the first antenna 350 is performed. That is, the power transmitting device 510 may output ping signals during the fob key search operations of the second antenna 360 and the third antenna 370, but may not output the ping signal during the fob key search operation of the first antenna 350. In this case, the ping signal control command may be a command to temporarily stop outputting the ping signal. Accordingly, the ping signal control command may include information about a time point when the output of the ping signal restarts. The power transmitting device 510 may output the ping signal according to the stop time point and restart time point included in the ping signal control command.

The processor 200 may control the ping signal to be output during the period in which the fob key search operation is performed in at least one of the second and third areas. As described above, the processor 200 may output the ping signal control command so that the ping signal is output during the fob key search operation of the second antenna 360 except for the fob key search period of the first antenna 350. Alternatively, the processor 200 may output the ping signal control command so that the ping signal is output during the fob key search operations of the second antenna 360 and the third antenna 370 except for the fob key search period of the first antenna 350.

The power transmitting device 510 may stop outputting the ping signal during a second period after a first period has elapsed after receiving the ping signal control command. The power transmitting device 510 may stop outputting the ping signal after about 10 to 30 ms has elapsed from the time point when the ping signal control command is received. At this time, a fob key search operation for the second area may be performed during the first period. The power transmitting device 510 may stop outputting the ping signal during the second period after the first period has elapsed. At this time, a fob key search operation for the first area may be performed during the second period.

When receiving a response signal corresponding to the fob key search signal from the fob key, the processor 200 may transmit a ping signal output start command or restart command. The processor 200 may transmit the ping signal output start command or restart command so that the output of the ping signal is immediately restarted or not stopped when it is confirmed that the fob key has been found. The ping signal output start command or restart command is a signal with a higher priority than the ping signal control command, and when receiving the ping signal output start command or resume command, the power transmitting device 510 may ignore the ping signal control command and output the ping signal. Therefore, the wireless charging process may be quickly performed in a state in which the search of the fob key has been completed.

A first operating frequency of the LF antenna for searching for the fob key may overlap a second operating frequency of the ping signal. For example, the first operating frequency and the second operating frequency of the LF antenna may be 125 kHz. Therefore, when the fob key search operation of the LF antenna and the output of the ping signal of the power transmitting device 510 are performed during the same period in the first area, signal interference can occur. The signal interference can degrade the accuracy of the search of the fob key, thereby causing a failure of the search of the fob key.

Therefore, the processor 200 according to the embodiment controls the ping signal not to be output while the fob key search operation is performed in the first area so that the fob key search operation may be performed smoothly in the first area.

For convenience, one or more figures are described by way of an example in which the steps are performed by a processor circuit. One, some, or all steps of the example method of a figure, or portions thereof, may be performed by one or more other circuits. One or some, steps of the example method of a figure may be omitted, performed in other orders, and/or otherwise modified, and/or one or more additional steps may be added.

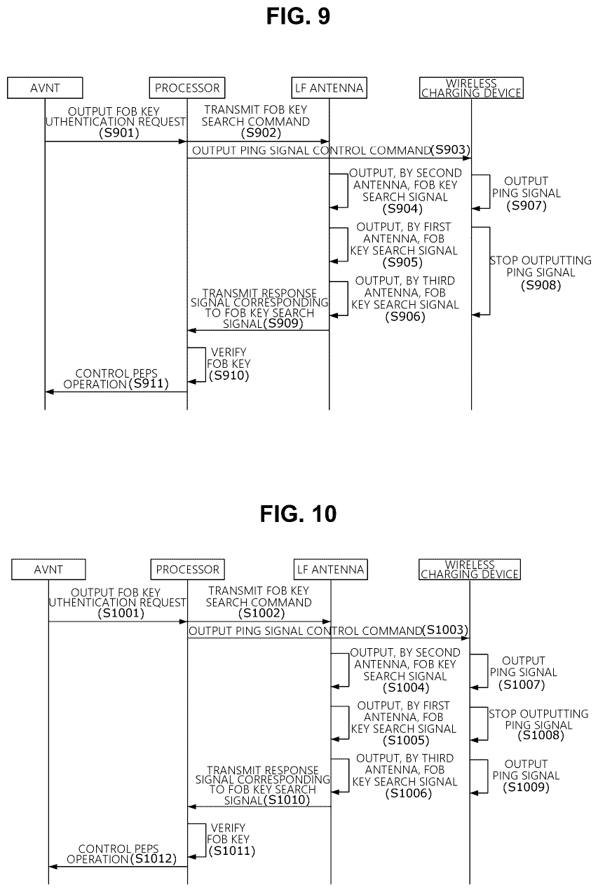

FIG. 9 is a flowchart of a vehicle control method according to an embodiment. Referring to FIG. 9, an AVNT may output a fob key authentication request to a processor when a fob key approaches (S901).

Next, the processor may transmit a fob key search command to an LF antenna in response to the fob key authentication request and output a ping signal control command to delay an output of a ping signal to a wireless charging device (S902 and S903).

According to the fob key search command, a second antenna, a first antenna, and a third antenna may sequentially output search signals for searching for a fob key according to a first operating frequency (S904 to S906).

At the same time, the wireless charging device outputs a ping signal during a fob key search operation of the second antenna in response to the ping signal control command and stops outputting the ping signal during fob key search operations of the first antenna and the third antenna (S907 and S908).

When receiving a response signal corresponding to the fob key search signal from the fob key, the processor verifies whether a digital key transmitted from a user terminal matches a registered key (S909 and S910).

Next, the processor provides an electronic device of the vehicle so that a PEPS function is provided when the digital key matches the registered key (S911).

FIG. 10 is a flowchart of a vehicle control method according to another embodiment. Referring to FIG. 10, an AVNT may output a fob key authentication request to a processor when a fob key approaches (S1001).

Next, the processor may transmit a fob key search command to an LF antenna in response to the fob key authentication request and output a ping signal control command to delay an output of a ping signal to a wireless charging device. In this case, the ping signal control command may be a command to temporarily stop outputting the ping signal. Therefore, the ping signal control command may include information about a time point when the output of the ping signal restarts (S1002 and S1003).

According to the fob key search command, a second antenna, a first antenna, and a third antenna may sequentially output search signals for searching for a fob key according to a first operating frequency (S1004 to S1006).

At the same time, the wireless charging device outputs a ping signal during a fob key search operation of the second antenna in response to the ping signal control command and stops outputting the ping signal during a fob key search operation of the first antenna. Subsequently, the wireless charging device re-outputs the ping signal during a fob key search operation of the third antenna according to a ping signal output start time point included in the ping signal control command (S1007 to S1009).

When receiving a response signal corresponding to the fob key search signal from the fob key, the processor verifies whether a digital key transmitted from a user terminal matches a registered key (S1010 and S1011).

Next, the processor provides an electronic device of the vehicle so that a PEPS function is provided when the digital key matches the registered key (S1012).

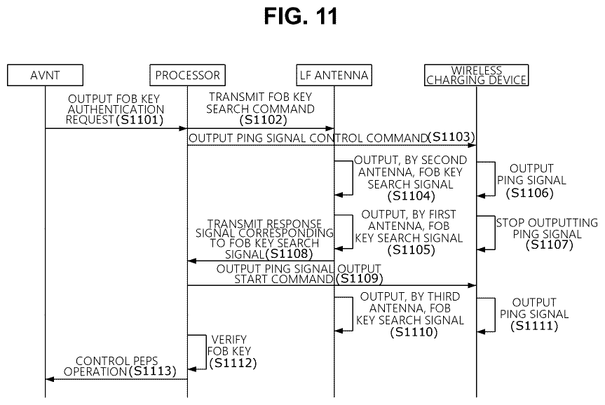

FIG. 11 is a flowchart of a vehicle control method according to still another embodiment. Referring to FIG. 11, an AVNT may output a fob key authentication request to a processor when a fob key approaches (S1101).

Next, the processor may transmit a fob key search command to an LF antenna in response to the fob key authentication request and output a ping signal control command to delay an output of a ping signal to a wireless charging device (S1102 and S1103).

According to the fob key search command, a second antenna and a first antenna may sequentially output search signals for searching for a fob key according to a first operating frequency (S1104 and S1105).

At the same time, the wireless charging device outputs a ping signal during a fob key search operation of the second antenna in response to the ping signal control command and stops outputting the ping signal during a fob key search operation of the first antenna (S1106 and S1107).

When receiving the response signal corresponding to the fob key search signal from the fob key, the processor transmits a ping signal output restart command to the wireless charging device (S1108 and S1109).

Subsequently, the third antenna may output a search signal for searching for the fob key according to the first operating frequency (S1110).

In addition, the wireless charging device outputs a ping signal according to the command to the ping signal output restart command (S1111).

The processor verifies whether a digital key transmitted from the user terminal matches a registered key according to the response signal (S1112).

Next, the processor provides an electronic device of the vehicle so that a PEPS function is provided when the digital key matches the registered key (S1113).

The term “unit” used in the present embodiment means a software or hardware component such as a field-programmable gate array (FPGA) or an ASIC, and the “unit” performs certain roles. However, the “unit” is not limited to software or hardware. The “unit” may be configured to be disposed in an addressable storage medium and configured to reproduce one or more processors. Therefore, as an example, the “unit” is components such as software components, object-oriented software components, class components, and task components, processes, functions, attributes, procedures, subroutines, segments of program code, drivers, firmware, microcode, circuits, data, database, data structures, tables, arrays, and variables. Functions provided in the components and “units” may be combined into the smaller number of components and “unit” or separated into additional components and “units.” Additionally, the components and “units” may be implemented to reproduce one or more CPUs in a device or a security multimedia card.

According to a vehicle and vehicle control method according to embodiments, it is possible to prevent signal interference between a low-frequency signal for searching for a fob key and a ping signal for wireless charging.

In addition, it is possible to prevent a failure of the search of the fob key.

In addition, it is possible to prevent the degradation of wireless charging efficiency by maximally ensuring an output of the ping signal.

Although the present disclosure has been described above with reference to exemplary embodiments, those skilled in the art will understand that the present disclosure may be modified and changed variously without departing from the spirit and scope of the present disclosure as described in the appended claims.

1. A vehicle comprising:
an authentication controller configured to output a fob key authentication request when a fob key approaches; and
a processor configured to transmit a fob key search command to antennas in response to the fob key authentication request, and to output a ping signal control command to delay an output of a detection signal to a wireless charging device;
wherein the fob key search command includes a fob key search command for a first area in which a wireless charging pad is disposed and areas other than the first area; and
wherein an output period of the detection signal controlled according to the detection signal control command does not overlap a fob key search period for the first area.

2. The vehicle of claim 1, wherein the processor is configured to sequentially output the fob key search command for the first area, starting from a second area adjacent to the first area, and a third area adjacent to the second area.

3. The vehicle of claim 2, wherein the processor is configured to control the output of the detection signal to be stopped through the detection signal control command before a period in which a fob key search operation is performed in the first area.

4. The vehicle of claim 2, wherein the processor is configured to control the output of the detection signal to be stopped through the detection signal control command during a period in which a fob key search operation is performed in the first area.

5. The vehicle of claim 4, wherein the processor is configured to control the detection signal to be output during a period in which the fob key search operation is performed in at least one of the second area and the third area.

6. The vehicle of claim 1, wherein a first operating frequency of the antennas for searching for the fob key overlaps a second operating frequency of the detection signal.

7. The vehicle of claim 1, wherein the wireless charging device is configured to stop the output of the detection signal during a second period after a first period has elapsed after receiving the detection signal control command.

8. The vehicle of claim 7, wherein a search of the fob key for the first area is performed within the second period.

9. The vehicle of claim 1, wherein the processor is configured to receive a response signal corresponding to a fob key search signal from the fob key.

10. The vehicle of claim 9, wherein the processor is configured to transmit a detection signal output start command or a detection signal restart command when receiving the response signal.

11. A vehicle control method comprising:
outputting, by an authentication controller, a fob key authentication request to a processor when a fob key approaches;
transmitting, by the processor, a fob key search command to antennas in response to the fob key authentication request; and
outputting, by the processor, a detection signal control command to control an output of a detection signal to a wireless charging device;
wherein the fob key search command includes a fob key search command for a first area in which a wireless charging pad is disposed and areas other than the first area; and
wherein an output period of the detection signal controlled according to the detection signal control command does not overlap a fob key search period for the first area.

12. The vehicle control method of claim 11, wherein transmitting the fob key search command includes:
transmitting the fob key search command to a second antenna disposed in a second area adjacent to the first area;
transmitting the fob key search command to a first antenna disposed in the first area; and
transmitting the fob key search command to a third antenna disposed in a third area adjacent to the second area.

13. The vehicle control method of claim 11, wherein outputting the detection signal control command includes controlling the output of the detection signal to be stopped through the detection signal control command before a period in which a fob key search operation is performed in the first area.

14. The vehicle control method of claim 12, wherein outputting the detection signal control command includes controlling the output of the detection signal to be stopped through the detection signal control command during a period in which a fob key search operation is performed in the first area.

15. The vehicle control method of claim 14, wherein outputting the detection signal control command includes controlling the detection signal to be output during the period in which the fob key search operation is performed in at least one of the second area and the third area.

16. The vehicle control method of claim 11, wherein a first operating frequency of the antennas for searching for the fob key overlaps a second operating frequency of the detection signal.

17. The vehicle control method of claim 11, further comprising stopping, by the wireless charging device receiving the detection signal control command, the output of the detection signal during a second period after a first period has elapsed.

18. The vehicle control method of claim 17, further comprising performing, by the antennas, a search of the fob key for the first area within the second period.

19. The vehicle control method of claim 11, further comprising transmitting, by the fob key, a response signal corresponding to a fob key search signal to the processor.

20. The vehicle control method of claim 19, further comprising transmitting, by the processor receiving the response signal, a detection signal output start command or a detection signal restart command to the wireless charging device.
